(19) United States
(12) Patent Application Publication
(10) Pub. No.: US 2018/0354323 A1
(43) Pub. Date: Dec. 13, 2018

(54) Sliding Hitch Adaptor

(71) Applicants: Arnold Lonzo Maynard, JR., Beckley, WV (US); Cecil Allan Perkins, Ghent, WV (US)

(72) Inventors: Arnold Lonzo Maynard, JR., Beckley, WV (US); Cecil Allan Perkins, Ghent, WV (US)

(21) Appl. No.: 15/986,155

(22) Filed: May 22, 2018

Related U.S. Application Data
(60) Provisional application No. 62/516,154, filed on Jun. 7, 2017.

(51) Int. Cl. B60D 1/44; B60D 1/06; B60D 1/62

(52) U.S. Cl. CPC B60D 1/44; B60D 1/62; B60D 1/065

(57) ABSTRACT

A slidable hitch adapter for transporting a trailer, such as a gooseneck trailer, is provided. The slidable hitch adapter may be installed in the bed of a truck and may be adjusted to any of a plurality of positions for improved stability or maneuverability when towing, braking, parking, turning, and navigating irregular terrain. The slidable hitch adapter includes a locking pin which may be in a locked position or an unlocked position. In the locked position, the adapter can withstand substantial lateral forces, such as those encountered during transport of a trailer engaged by the adapter. In the unlocked position, the adapter hitch position may be adjusted to prepare the adapter for towing, braking, parking, turning, or navigating irregular terrain.

### CROSS REFERENCE TO RELATED APPLICATIONS

This application claims priority under 35 U.S.C. § 119(e) to U.S. Provisional Application No. 62/516,154 filed on Jun. 7, 2017. The above identified patent application is incorporated by reference herein in its entirety to provide continuity of disclosure.

### BACKGROUND OF THE INVENTION

Pickup trucks are often used for towing trailers. Three types of trailer connections include a fifth-wheel type, a bumper type, and a gooseneck type. Fifth-wheel and gooseneck types are designed to place the weight of the trailer above the rear axle of the truck, in the bed of the truck. This position is advantageous for towing the trailer at road speeds, in part because it ensures that the trailer does not lift the front axle of the truck, as may occur with a bumper type connection. For many applications, gooseneck connection types offer improved stability compared to fifth-wheel connection types. However, the position of the gooseneck hitch is generally fixed and not adjustable. This characteristic may limit the available turn radius, interfere with navigating irregular or hilly terrain, and result in property damage when the trailer collides with the body of the pickup truck.

Therefore, there is a need in the art for an improved hitch adaptor which can be adjusted to improve maneuverability. The present invention addresses this unmet need.

### FIELD OF THE INVENTION

The present invention relates to an adjustable hitch adaptor.

Devices have been disclosed in the art that relate to trailer hitches. These include devices that have been patented and published in patent application publications. In view of the devices disclosed in the art, it is submitted that there is a need in the art for an improvement to existing trailer hitches. In view of the present disclosure, it is submitted that the present invention substantially diverges in structural and functional elements from devices in the art, and the instant invention substantially fulfills an unmet need in the art.

### SUMMARY OF THE INVENTION

In view of the disadvantages inherent in the known types of trailer hitches in the art, the present invention provides a new and improved adjustable hitch, wherein the same can be utilized for providing improved stability and maneuverability to a user when operating a truck connected to a trailer, such as a gooseneck trailer.

It is therefore an object of the present invention to provide an adjustable hitch adaptor for improving stability of a trailer engaged to a truck when the trailer is being towed at road speeds, and for improving maneuverability of the trailer engaged to the truck when the trailer is being towed at low speeds, navigating irregular terrain, or parking.

It is another object of the present invention to provide a method for improving stability of a trailer engaged to a truck when the trailer is being towed at road speeds, and for improving maneuverability of the trailer engaged to the truck when the trailer is being towed at low speeds, navigating irregular terrain, or parking.

Another object of the present invention is to provide a slidable hitch adaptor.

Yet another object of the present invention is to provide a slidable gooseneck hitch adaptor.

Another object of the present invention is to provide an adjustable hitch adaptor that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a first perspective view of an embodiment of the sliding hitch adaptor installed in a bed of a pickup truck.

FIG. 2 depicts a second perspective view of an embodiment of the sliding hitch adaptor installed in a bed of a pickup truck.

FIG. 3 depicts an exploded view of an embodiment of the sliding hitch adaptor.

FIG. 4 depicts a top-down perspective view of an embodiment of the sliding hitch adaptor in a forward position, with a locking pin in a locked position.

FIG. 5 depicts a top-down perspective view of an embodiment of the sliding hitch adaptor in a forward position, with a locking pin in an unlocked position.

FIG. 6 depicts a top-down perspective view of an embodiment of the sliding hitch adaptor in an intermediate position, with a locking pin in an unlocked position.

FIG. 7 depicts a top-down perspective view of an embodiment of the sliding hitch adaptor in a rearward position, with a locking pin in an unlocked position.

FIG. 8 depicts a top-down perspective view of an embodiment of the sliding hitch adaptor in a rearward position, with a locking pin in a locked position.

FIG. 9 depicts a first perspective view of an alternate embodiment of the sliding hitch adaptor installed in a bed of a pickup truck.

FIG. 10 depicts a second perspective view of an alternate embodiment of the sliding hitch adaptor installed in a bed of a pickup truck.

FIG. 11 depicts an exploded view of an alternate embodiment of the sliding hitch adaptor.

FIG. 12 depicts a top-down perspective view of an alternate embodiment of the sliding hitch adaptor in a forward position, with a locking pin in a locked position.

FIG. 13 depicts a top-down perspective view of an alternate embodiment of the sliding hitch adaptor in a forward position, with a locking pin in an unlocked position.

FIG. 14 depicts a top-down perspective view of an alternate embodiment of the sliding hitch adaptor in an intermediate position, with a locking pin in an unlocked position.

FIG. 15 depicts a top-down perspective view of an alternate embodiment of the sliding hitch adaptor in a rearward position, with a locking pin in an unlocked position.

FIG. 16 depicts a top-down perspective view of an alternate embodiment of the sliding hitch adaptor in a rearward position, with a locking pin in a locked position.

### DETAILED DESCRIPTION OF THE INVENTION

A slidable hitch adaptor is provided for adjusting a position of a trailer hitch relative to a rear axle of a truck. The slidable hitch adaptor may be in a forward position, wherein the hitch is substantially above the rear axle, or may be in a rearward position, wherein the hitch is substantially behind the rear axle. If the hitch is in the forward position, the weight of the trailer bears down on the frame and wheels of the truck, stabilizing the contact between the tires and the road for towing at higher speeds. If the hitch is in the rearward position, the horizontal clearance between the truck cab and the trailer is increased for making sharp turns or navigating irregular terrain at lower speeds. The hitch position may be adjusted manually, or by automated means, such as with an electric actuator or electric solenoid.

Reference is now made to the drawings, which depict one or more exemplary embodiments of the invention.

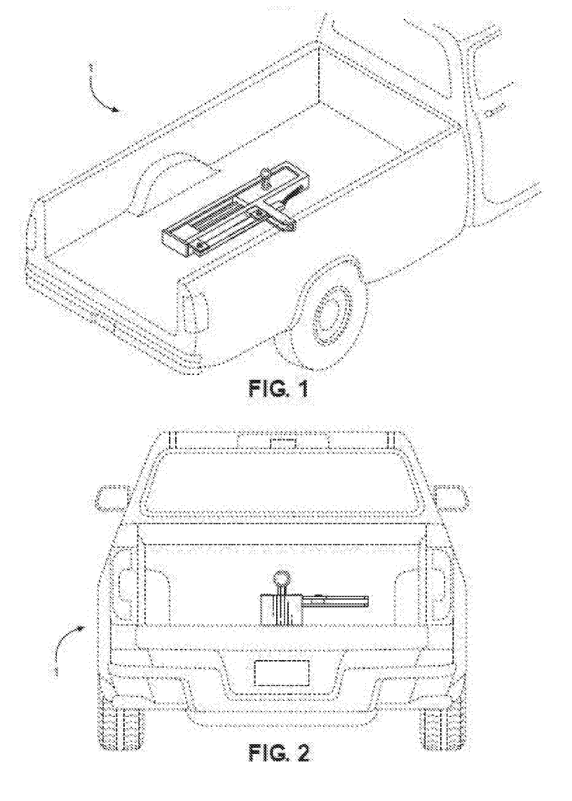

Referring now to FIG. 1, there is depicted a first perspective view of an exemplary manual sliding hitch adaptor 1 installed in a bed of a pickup truck. The manual sliding hitch adaptor 1 is installed so that if the hitch is in a forward position, the hitch is substantially above the rear axle, and that if the hitch is in a rearward position, the hitch is substantially behind the rear axle. Generally, the forward position is used for high speed towing and transport of a trailer on a road, and the rearward position is used for low speed towing and transport of a trailer on an irregular terrain.

Referring now to FIG. 2, there is depicted a second perspective view of an exemplary manual sliding hitch adaptor 1 installed in a bed of a pickup truck. The manual sliding hitch adaptor 1 provides a low profile for accepting a ball hitch from a trailer, such as a gooseneck trailer. The compact shape of the manual sliding hitch adaptor 1 also ensures a substantial portion of the truck bed remains available for storing or transporting other items.

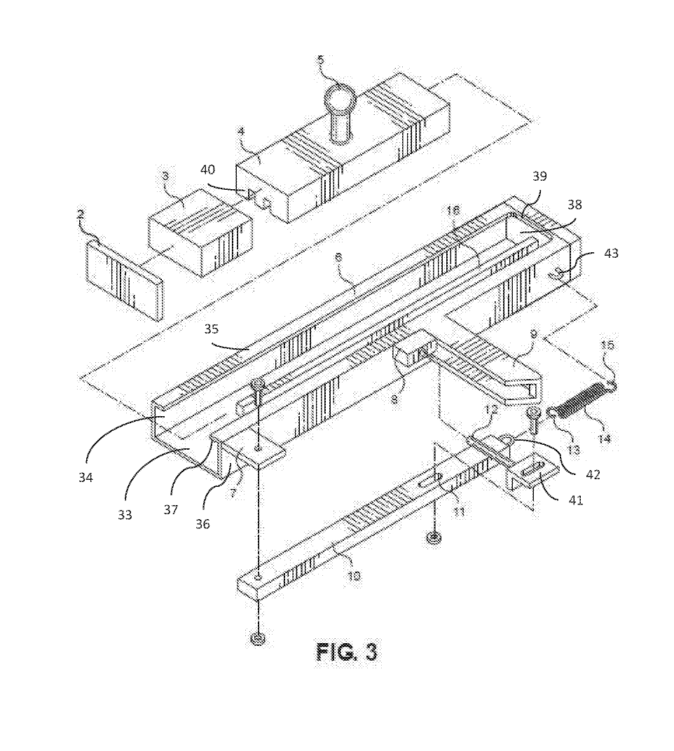

Referring now to FIG. 3, there is depicted an exploded view of an exemplary manual sliding hitch adaptor. A housing 6 comprises one or more tracks 16 disposed therein, such that a platform 4, which comprises a ball hitch 5, may be slidably disposed on the track 16 inside the housing 6. After the platform 4 is installed, a platform support block 3 and a housing rearward side 2 are inserted into a rearward portion of the housing 6, and secured. The housing 6 comprises a housing bottom side 33, a housing left side 34 comprising a housing left side ridge 35, a housing right side 36 comprising a housing right side ridge 37, a housing forward side 38 comprising a housing forward side ridge 39, and a housing rearward side 2. The housing sides (33, 34, 36, 38, 2) and housing side ridges (35, 37, 39) ensure that the platform 4 remains securely in the housing 6, and restrict vertical movement of the platform 4 relative to the track 16. The platform 4 has a platform bottom 40 that is configured to be slidably disposed on the track 16, and enable the platform 4 to slide forward and backward within the housing 6, on the track 16. The track 16 comprises at least one track ridge elevated from an interior surface of the housing bottom side 33, and the platform bottom 40 comprises at least one platform bottom recess configured to slidably accept the at least one track ridge. Generally, the number of track ridges is equal to the number of platform bottom recesses configured to slidably accept the track ridges. The manual sliding hitch adaptor further comprises a locking pin guide 9, configured to guide a locking pin 12 through a locking pin acceptor 8, and into the housing 6, to place the manual sliding hitch adaptor in a locked position. The locking pin 12 is connected to a locking pin slider plate 41, which is connected to a locking pin actuator arm 10 by way of a locking pin actuator arm slider plate acceptor 11 and a suitable fastener. The locking pin actuator arm 10 is hingedly connected on a rearward end thereof to the housing 6 by way of a housing locking pin actuator arm acceptor plate 7 and a suitable fastener. A spring 14 is connected on end 13 to a locking pin actuator arm spring loop 42, and on end 15 to a housing spring loop 43. When assembled, the spring 14 applies a biasing force on the locking pin actuator arm 10, biasing the locking pin actuator arm 10 toward the housing 6, thereby securing the locking pin 12 within the housing 6 and maintaining the manual sliding hitch adaptor in a locked position. To place the manual sliding hitch adaptor in an unlocked position, the bias of the spring must be overcome by applying a force to the locking pin actuator arm 10 in the direction opposite the bias of the spring 14. This force may be applied by manually pulling the locking pin actuator arm 10 outward at the locking pin actuator arm spring loop 42, or a position adjacent thereto, or by manually pulling the locking pin actuator arm 10 outward at another position thereon, as would be understood by a skilled artisan.

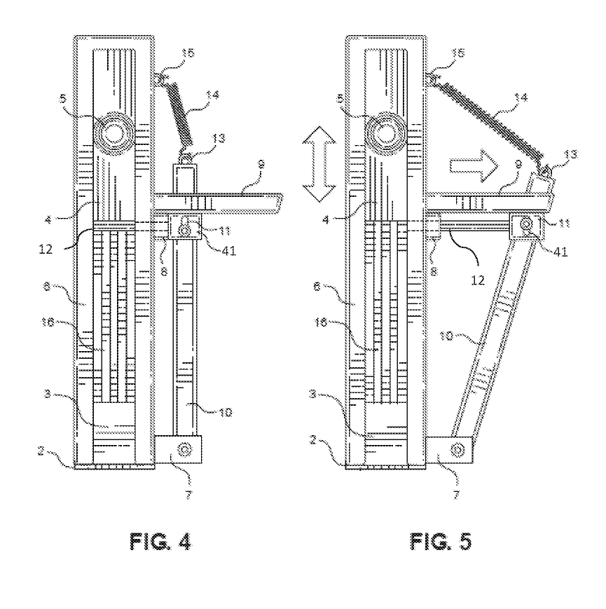

Referring now to FIG. 4, there is depicted a top-down perspective view of an exemplary manual sliding hitch adaptor in a forward position, with the locking pin 12 in a locked position. In this position, a bias of the spring 14 secures the locking pin 12 substantially within the housing 6. In the example depicted, the manual sliding hitch adaptor is locked (i.e., the locking pin actuator arm 10 is parallel to the housing 6) in a forward position (i.e., the platform 4 is forward, substantially above a rear axle of a truck in which the sliding hitch adaptor is installed).

Referring now to FIG. 5, there is depicted a top-down perspective view of an exemplary manual sliding hitch adaptor in a forward position, with the locking pin 12 in an unlocked position. In this position, an outward force is applied to the locking pin actuator arm 10, thereby overcoming the bias of the spring 14 and removing the locking pin 12 from the housing 6, and placing it substantially within or adjacent to the locking pin guide 9. In the example depicted, the locking pin 12 is placed substantially outside the housing 6, adjacent to the locking pin guide 9 (i.e., the locking pin actuator arm 10 is angled relative to the housing 6).

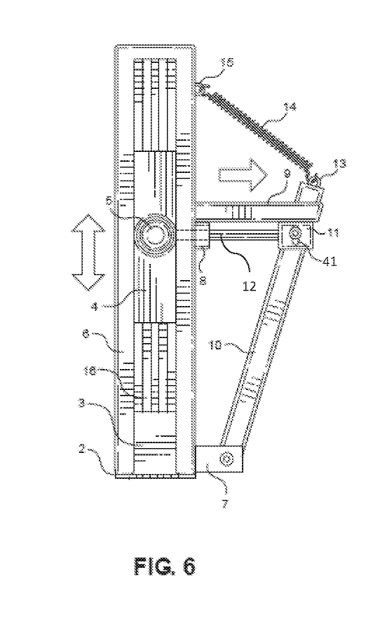

Referring now to FIG. 6, there is depicted a top-down perspective view of an exemplary manual sliding hitch adaptor in an intermediate position, with the locking pin 12 in an unlocked position. This figure demonstrates sliding of the platform 4 along the track 16, which may occur if a rearward force is applied to the platform 4, for example, by driving a truck (not shown) with the manual sliding hitch adaptor installed, with a trailer (not shown) connected thereon, in a forward direction. The locking pin actuator arm 10 is angled relative to the housing 6.

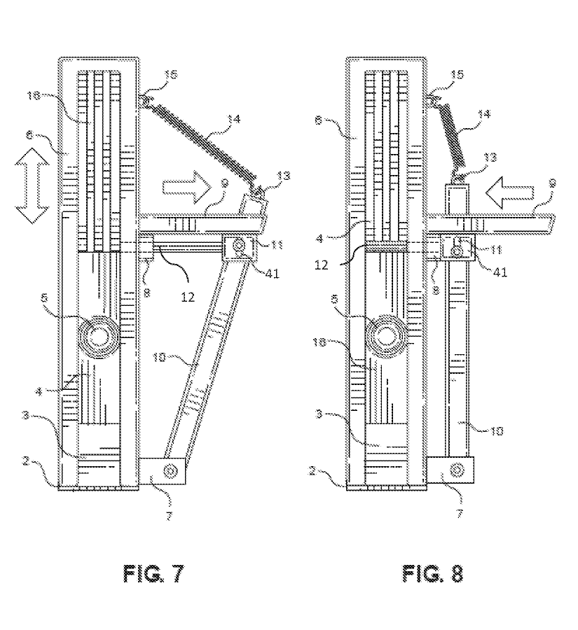

Referring now to FIG. 7, there is depicted a top-down perspective view of an exemplary manual sliding hitch adaptor in a rearward position, with the locking pin 12 in an unlocked position. This figure demonstrates completion of the sliding movement depicted in FIG. 6, wherein the platform 4 comes to rest against the platform support block 3. The locking pin actuator arm 10 is angled relative to the housing 6.

Referring now to FIG. 8, there is depicted a top-down perspective view of an exemplary manual sliding hitch adaptor in a rearward position, with the locking pin 12 in a locked position. This figure demonstrates release of the force opposing the bias of the spring 14, which allows the spring 14 to pull the locking pin actuator arm 10 back toward the housing 6. This in turn causes the locking pin 12 to be placed within the housing 6, securing the locking pin 12 in the locked position. In the example depicted, the manual sliding hitch adaptor is locked (i.e., the locking pin actuator arm 10 is parallel to the housing 6) in a rearward position (i.e., the platform 4 is rearward, substantially behind a rear axle of a truck in which the sliding hitch adaptor is installed).

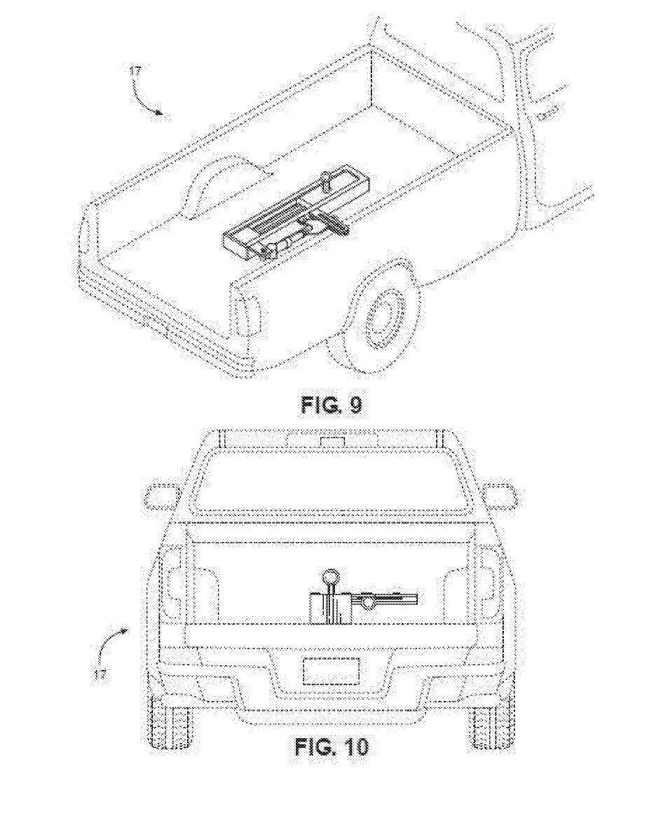

Referring now to FIG. 9, there is depicted a first perspective view of an exemplary electric sliding hitch adaptor 17 installed in a bed of a pickup truck. The electric sliding hitch adaptor 17 is installed so that if the hitch is in the forward position, the hitch is substantially above the rear axle, and that if the hitch is in the rearward position, the hitch is substantially behind the rear axle. Generally, the forward position is used for high speed towing and transport of a trailer on a road, and the rearward position is used for low speed towing and transport of a trailer on an irregular terrain.

Referring now to FIG. 10, there is depicted a second perspective view of an exemplary electric sliding hitch adaptor 17 installed in a bed of a pickup truck. The electric sliding hitch adaptor 17 provides a low profile for accepting a ball hitch from a trailer, such as a gooseneck trailer. The compact shape of the electric sliding hitch adaptor 17 also ensures a substantial portion of the truck bed remains available for storing or transporting other items.

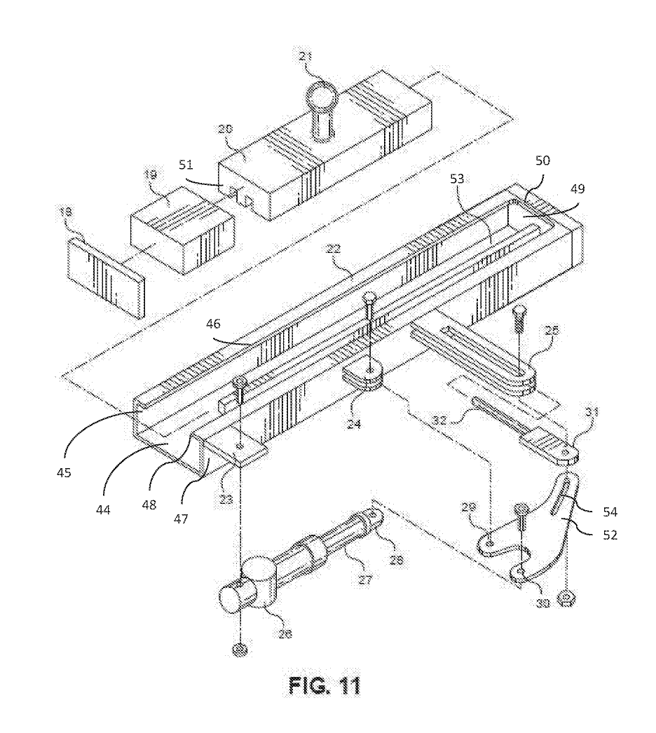

Referring now to FIG. 11, there is depicted an exploded view of an exemplary electric sliding hitch adaptor. A housing 22 comprises one or more tracks 53 disposed therein, such that a platform 20, which comprises a ball hitch 21, may be slidably disposed on the track 53 inside the housing 22. After the platform 20 is installed, a platform support block 19 and a housing rearward side 18 are inserted into a rearward portion of the housing 22, and secured. The housing 22 comprises a housing bottom side 44, a housing left side 45 comprising a housing left side ridge 46, a housing right side 47 comprising a housing right side ridge 48, a housing forward side 49 comprising a housing forward side ridge 50, and a housing rearward side 18. The housing sides (44, 45, 47, 49) and housing side ridges (46, 48, 50) ensure that the platform 20 remains securely in the housing 22, and restrict vertical movement of the platform 20 relative to the track 53. The platform 20 has a platform bottom 51 that is configured to be slidably disposed on the track 53, and enable the platform 20 to slide forward and backward within the housing 22, on the track 53. The track 53 comprises at least one track ridge elevated from an interior surface of the housing bottom side 44, and the platform bottom 51 comprises at least one platform bottom recess configured to slidably accept the at least one track ridge. Generally, the number of track ridges is equal to the number of platform bottom recesses configured to slidably accept the track ridges. The electric sliding hitch adaptor further comprises a locking pin guide 25, configured to guide a locking pin 32 into the housing 22, to place the electric sliding hitch adaptor in a locked position. The locking pin 32 is connected to a locking pin actuator arm 52 by way of a locking pin slider plate 31. The locking pin actuator arm 52 comprises three connection positions on a structure having a shape roughly similar to an “h” or a Greek letter “k”. The locking pin actuator arm 52 is configured to rotate about a connection position 29, upon application of a force to a first position 30, which actuates a second position having an elongated slot 54. The elongated slot 54 is configured to slidably engage a suitable fastener, which secures the locking pin slider plate 31 within two prongs of the locking pin guide 25. The operable range of the locking pin actuator arm 52 is such that in an unlocked position, the locking pin 32 is not completely removed from an opening in a side of the housing 22, thereby causing the locking pin to not deviate from perpendicular to the housing 22 during operation. The locking pin actuator arm 52 is hingedly connected on a first position 29 to the housing 22 by way of a housing locking pin actuator arm acceptor plate 24 and a suitable fastener. An electric actuator 26 is connected on end 28 to a locking pin actuator arm attachment site 30, and on a rearward end thereof to the housing 22 by way of a housing actuator attachment plate 23 and a suitable fastener. When assembled, the electric actuator 26 may extend an electric actuator arm 27, applying a biasing force on the locking pin actuator arm 52, biasing the locking pin actuator arm 52 toward the housing 22, thereby securing the locking pin 32 within the housing 22 and maintaining the electric sliding hitch adaptor in a locked position. To place the electric sliding hitch adaptor in an unlocked position, the electric actuator 26 may contract or shorten the electric actuator arm 27, applying a biasing force on the locking pin actuator arm 52, biasing the locking pin actuator arm 52 away from the housing 22, thereby securing the locking pin 32 within a locking pin guide 25 and maintaining the electric sliding hitch adaptor in the unlocked position.

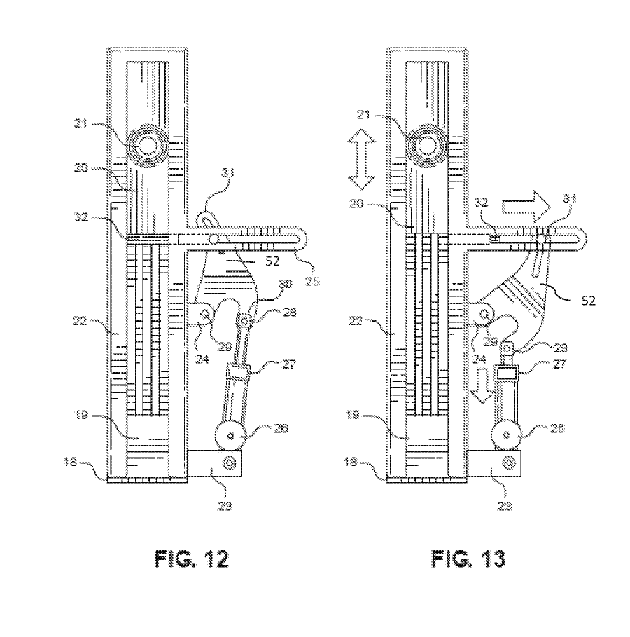

Referring now to FIG. 12, there is depicted a top-down perspective view of an exemplary electric sliding hitch adaptor in a forward position, with the locking pin 32 in a locked position. In this position, a bias of the electric actuator 26 secures the locking pin 32 substantially within a housing 22. In the example depicted, the electric sliding hitch adaptor is locked (i.e., locking pin 32 is substantially within the housing 22), in a forward position (i.e., the platform 20 is forward, substantially above a rear axle of a truck in which the sliding hitch adaptor is installed).

Referring now to FIG. 13, there is depicted a top-down perspective view of an exemplary electric sliding hitch adaptor in a forward position, with the locking pin 32 in an unlocked position. In the forward position, the electric actuator 26 has shortened the electric actuator arm 27, thereby rotating the locking pin actuator arm 52 about a hinged housing connection 29 thereof, thereby substantially moving the locking pin 32 from the housing 22 to the locking pin guide 25, and placing it substantially within or adjacent to the locking pin guide 25. In the example depicted, the locking pin 32 is placed substantially outside the housing 22, within the locking pin guide 25.

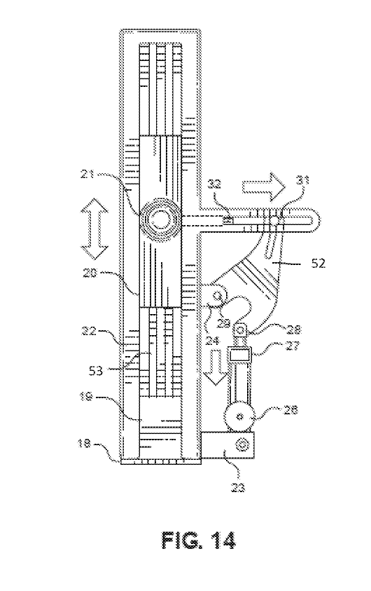

Referring now to FIG. 14, there is depicted a top-down perspective view of an exemplary electric sliding hitch adaptor in an intermediate position, with the locking pin 32 in an unlocked position. This figure demonstrates sliding of the platform 20 along the track 53, which may occur if a rearward force is applied to the platform 20, for example, by driving a truck (not shown) with the electric sliding hitch adaptor installed, with a trailer (not shown) connected thereon, in a forward direction.

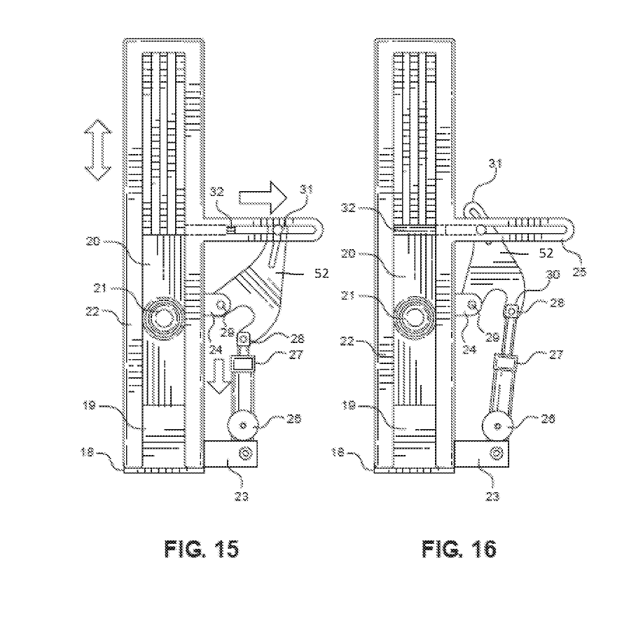

Referring now to FIG. 15, there is depicted a top-down perspective view of an exemplary electric sliding hitch adaptor in a rearward position, with the locking pin 32 in an unlocked position. This figure demonstrates completion of the sliding movement depicted in FIG. 14, wherein the platform 20 comes to rest against the platform support block 19.

Referring now to FIG. 16, there is depicted a top-down perspective view of an exemplary electric sliding hitch adaptor in a rearward position, with the locking pin 32 in a locked position. In the example depicted, the electric sliding hitch adaptor is locked (i.e., the locking pin actuator arm 52 is parallel to the housing 22) in a rearward position (i.e., the platform 20 is rearward, substantially behind a rear axle of a truck in which the sliding hitch adaptor is installed).

In one aspect, the present invention provides a slidable hitch adaptor, comprising: a housing, a track disposed in the housing, a platform slidably disposed on the track, a locking pin guide, a locking pin slidably disposed in the locking pin guide, a means for placing the locking pin in a locked position, and a means for placing the locking pin in an unlocked position. In one embodiment, the locked position restricts lateral movement of the platform relative to the track. In one embodiment, the unlocked position allows lateral movement of the platform relative to the track. In one embodiment, the housing comprises a housing bottom side, a housing left side, a housing right side, and a housing forward side. In one embodiment, a lubricant is applied to at least one selected from the group including, but not limited to: the track, the platform, the locking pin, the locking pin guide, and a combination thereof. In one embodiment, the lubricant is selected from the group including, but not limited to: a grease, an oil, and a combination thereof.

In one embodiment, the sliding hitch adaptor comprises a ball hitch disposed on the platform. In one embodiment, the ball hitch is a standard size. In one embodiment, the ball hitch is a non-standard size.

In one embodiment, the sliding hitch adaptor comprises a means for restricting vertical movement of the platform relative to the track. In one embodiment, the means for restricting vertical movement of the platform relative to the track comprises an additional structural feature of the housing.

In one embodiment, the means for restricting vertical movement of the platform relative to the track comprises: a housing left side ridge, a housing right side ridge, and a housing forward side ridge; wherein the housing left side ridge extends from an upper portion of the housing left side toward a center of an upper portion of the housing, wherein the housing right side ridge extends from an upper portion of the housing right side toward the center of the upper portion of the housing, and wherein the housing forward side ridge extends from an upper portion of the housing forward side toward the center of the upper portion of the housing. In one embodiment, the upper portion of the housing is substantially covered by a material to prevent or limit entry, into the interior of the housing, of at least one selected from the group including, but not limited to: moisture, water, dirt, debris, soap, detergent, and a combination thereof.

In one embodiment, the locked position comprises the locking pin positioned substantially in the housing. In one embodiment, the housing is configured to receive and secure the locking pin. In one embodiment, the locking pin is cylindrical. In one embodiment, the locking pin is not cylindrical.

In one embodiment, the unlocked position comprises the locking pin positioned substantially in the locking pin guide. In one embodiment, the locking pin guide is configured to receive and secure the locking pin. In one embodiment, the locking pin is cylindrical. In one embodiment, the locking pin is not cylindrical.

In one embodiment, the means for placing the locking pin in the locked position comprises at least one spring and a locking pin actuator arm; wherein the at least one spring is attached on a first portion thereof to the housing and on a second portion thereof to the locking pin actuator arm, and wherein the locking pin actuator arm is attached on a first portion thereof to the housing, on a second portion thereof to the at least one spring, and on a third portion thereof to the locking pin. In one embodiment, the at least one spring is attached on a first end thereof to the housing and on a second end thereof to a second end of the locking pin actuator arm, wherein the locking pin actuator arm is attached on a first end thereof to the housing, on the second end thereof to the second end of the spring, and on an intermediate position thereof to the locking pin. In one embodiment, the locking pin actuator arm is hingedly attached to the housing. In one embodiment, the locking pin actuator arm is hingedly attached to the locking pin. In one embodiment, the locking pin actuator arm is hingedly attached to both the housing and the locking pin.

In one embodiment, the means for placing the locking pin in the unlocked position comprises at least one spring and a locking pin actuator arm; wherein the at least one spring is attached on a first portion thereof to the housing and on a second portion thereof to the locking pin actuator arm, and wherein the locking pin actuator arm is attached on a first portion thereof to the housing, on a second portion thereof to the at least one spring, and on a third portion thereof to the locking pin. In one embodiment, the at least one spring is attached on a first end thereof to the housing and on a second end thereof to a second end of the locking pin actuator arm, wherein the locking pin actuator arm is attached on a first end thereof to the housing, on the second end thereof to the second end of the spring, and on an intermediate position thereof to the locking pin. In one embodiment, the locking pin actuator arm is hingedly attached to the housing. In one embodiment, the locking pin actuator arm is hingedly attached to the locking pin. In one embodiment, the locking pin actuator arm is hingedly attached to both the housing and the locking pin. In one embodiment, the means for placing the locking pin in the unlocked position comprises at least one force applicator selected from the group including, but not limited to: a string, a rope, a chain, a cord, a pulley, and a combination thereof. In one embodiment, the at least one force applicator is attached to the locking pin actuator arm. In one embodiment, the means for placing the locking pin in the unlocked position comprises an application of force against a bias of the spring, optionally by way of the at least one force applicator, whereupon sufficient force being applied thereto, the locking pin actuator arm moves away from the housing, the locking pin substantially exits the housing, and the locking pin substantially enters the locking pin guide.

In one embodiment, the means for placing the locking pin in the locked position comprises at least one electric actuator and a locking pin actuator arm; wherein the at least one electric actuator is attached on a first portion thereof to the housing and on a second portion thereof to the locking pin actuator arm, and wherein the locking pin actuator arm is attached on a first portion thereof to the housing, on a second portion thereof to the at least one electric actuator, and on a third portion thereof to the locking pin. In one embodiment, the at least one electric actuator is attached on a first end thereof to the housing and on a second end thereof to a second end of the locking pin actuator arm, wherein the locking pin actuator arm is attached on a first end thereof to the housing, on the second end thereof to the second end of the electric actuator, and on a third end thereof to the locking pin. In one embodiment, the locking pin actuator arm is hingedly attached to the housing. In one embodiment, the locking pin actuator arm is hingedly attached to the locking pin. In one embodiment, the locking pin actuator arm is hingedly attached to both the housing and the locking pin. In one embodiment, the electric actuator extends to rotate the locking pin actuator arm about a hinged housing connection thereof, thereby moving the locking pin substantially from the locking pin guide to the housing.

In one embodiment, the means for placing the locking pin in the unlocked position comprises at least one electric actuator and a locking pin actuator arm; wherein the at least one electric actuator is attached on a first portion thereof to the housing and on a second portion thereof to the locking pin actuator arm, and wherein the locking pin actuator arm is attached on a first portion thereof to the housing, on a second portion thereof to the at least one electric acutator, and on a third portion thereof to the locking pin. In one embodiment, the at least one electric actuator is attached on a first end thereof to the housing and on a second end thereof to a second end of the locking pin actuator arm, wherein the locking pin actuator arm is attached on a first end thereof to the housing, on the second end thereof to the second end of the electric actuator, and on a third end thereof to the locking pin. In one embodiment, the locking pin actuator arm is hingedly attached to the housing. In one embodiment, the locking pin actuator arm is hingedly attached to the locking pin. In one embodiment, the locking pin actuator arm is hingedly attached to both the housing and the locking pin. In one embodiment, the electric actuator contracts to rotate the locking pin actuator arm about a hinged housing connection thereof, thereby moving the locking pin substantially from the housing to the locking pin guide.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the instant invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1. A slidable hitch adaptor, comprising:
a housing;
a track disposed in the housing,
a platform slidably disposed on the track,
a locking mechanism comprising a locking pin movable between a locked position and an unlocked position;
wherein the locked position restricts lateral movement of the platform relative to the track, and
wherein the unlocked position allows lateral movement of the platform relative to the track.

2. The slidable hitch adaptor of claim 1, comprising a ball hitch disposed on the platform.

3. The slidable hitch adaptor of claim 1, wherein the housing comprises a housing bottom side, a housing left side, a housing right side, a housing forward side, a housing rearward side, a housing left side ridge, a housing right side ridge, a housing forward side ridge, and a housing rearward side ridge;
wherein the housing left side ridge extends from an upper portion of the housing left side toward a center of an upper portion of the housing,
wherein the housing right side ridge extends from an upper portion of the housing right side toward the center of the upper portion of the housing,
wherein the housing forward side ridge extends from an upper portion of the housing forward side toward the center of the upper portion of the housing, and
wherein the housing rearward side ridge extends from an upper portion of the housing rearward side toward the center of the upper portion of the housing.

4. The slidable hitch adaptor of claim 1, wherein the locked position comprises the locking pin positioned substantially in an interior volume of the housing.

5. The slidable hitch adaptor of claim 4, wherein the unlocked position comprises the locking pin positioned substantially in an interior volume of a locking pin guide.

6. The slidable hitch adaptor of claim 4, wherein the unlocked position comprises the locking pin positioned substantially adjacent to a locking pin guide.

7. The slidable hitch adaptor of claim 5, comprising at least one spring and a locking pin actuator arm;
wherein the at least one spring is attached on a first portion thereof to the housing and on a second portion thereof to the locking pin actuator arm, and
wherein the locking pin actuator arm is attached on a first portion thereof to the housing, on a second portion thereof to the at least one spring, and on a third portion thereof to the locking pin.

8. The slidable hitch adaptor of claim 6, comprising at least one electric actuator and a locking pin actuator arm;
wherein the at least one electric actuator is attached on a first portion thereof to the housing and on a second portion thereof to the locking pin actuator arm, and
wherein the locking pin actuator arm is attached on a first portion thereof to the housing, on a second portion thereof to the at least one electric actuator, and on a third portion thereof to the locking pin.

9. The slidable hitch adaptor of claim 2, wherein the platform is in a forward position, thereby configuring the slidable hitch adaptor for towing a trailer connected to the ball hitch.

10. The slidable hitch adaptor of claim 2, wherein the platform is in a rearward position, thereby configuring the slidable hitch adaptor for maneuvering a trailer connected to the ball hitch.

11. The slidable hitch adaptor of claim 1, comprising a platform support block secured in a rearward portion of the housing.

12. The slidable hitch adaptor of claim 3, wherein the track is disposed on an interior surface of the housing bottom side.

13. The slidable hitch adaptor of claim 12, wherein the track comprises at least one track ridge elevated from the interior surface of the housing bottom side.

14. The slidable hitch adaptor of claim 13, wherein the track comprises two track ridges elevated from the interior surface of the housing bottom side.

15. The slidable hitch adaptor of claim 5, wherein the locking pin guide extends perpendicularly from the housing.

16. The slidable hitch adaptor of claim 6, wherein the locking pin guide extends perpendicularly from the housing.

17. The slidable hitch adaptor of claim 7, wherein in the locked position, the locking pin actuator arm is parallel to the housing, and the at least one spring is substantially slack; wherein in the unlocked position, the locking pin actuator arm is angled relative to the housing, and the at least one spring is substantially taut.

18. The slidable hitch adaptor of claim 8, wherein in the locked position, the third portion of the locking pin actuator arm is near to the housing, and the at least one electric actuator is in an extended position; wherein in the unlocked position, the third portion of the locking pin actuator arm is far from the housing, and the at least one electric actuator is in a contracted position.
